(19) United States
(12) Patent Application Publication
(10) Pub. No.: US 2019/0040311 A1
(43) Pub. Date: Feb. 7, 2019

(54) METHODS FOR ENHANCING APPLICATIONS OF ELECTRICALLY CONTROLLED PROPELLANTS IN SUBTERRANEAN FORMATIONS

(71) Applicant: Halliburton Energy Services, Inc., Houston, TX (US)

(72) Inventors: Philip D. NGUYEN, Houston, TX (US); Ronald Glen DUSTERHOFT, Katy, TX (US); Lee J. HALL, The Woodlands, TX (US)

(21) Appl. No.: 16/074,695

(22) PCT Filed: May 26, 2016
(86) PCT No.: PCT/US16/34277

§ 371 Date: Aug. 1, 2018

(51) Int. Cl. C09K 8/80; C09K 8/70; E21B 43/17; E21B 43/267

(52) U.S. Cl. CPC C09K 8/805; C09K 8/70; C09K 8/725; E21B 43/267; E21B 43/17

(57) ABSTRACT

Methods and systems for enhancing a fracture in a subterranean formation are provided. An example method comprises introducing a proppant-free fluid into the fracture; introducing a propping fluid into the fracture, wherein the propping fluid comprises a proppant particulate and an electrically controllable propellant; transmitting an electric current into the fracture; allowing the electrically controllable propellant to ignite within the fracture; and withdrawing the electric current.

### TECHNICAL FIELD

The present disclosure relates to the use of electrically controlled propellants for fracturing operations and more particularly to the use of electrically controlled propellants to enhance complex fracture networks and to measure the effective dimensions of propped fractures.

### BACKGROUND

Subterranean formations may be fractured to improve well productivity by placing or enhancing fractures which run from a wellbore into a surrounding subterranean formation. Fracturing operations may generally be performed by injecting a fracturing fluid into a wellbore penetrating a subterranean formation at a pressure sufficient to create a fracture in the formation or to induce generation of secondary fractures for enhancing connectivity with the existing natural fractures in the formation. Proppant particulates may be placed in the fracture to prevent the fracture from closing once the pressure is released. Upon placement the proppant particulates usually form proppant packs in or near desired fractures. These proppant packs may maintain the integrity of those fractures to create conductive paths to the wellbore for desirable fluids to flow.

Complex fracture networks may be formed off of a primary fracture to enhance conductivity. The complex fracture network may feature fractures of various sizes that branch off from the primary fracture to form the fracture network. These secondary fractures may in turn also possess branching tertiary fractures and so on. The branching fractures are of various sizes and require various sizes of particulate proppant to prop open the fractures and maintain the complex fracture network.

The geometry of a fracture may affect the efficiency of the fracturing process and the success of a fracturing operation. Some methods used to map fractures include the use of explosive, implosive, or rapidly combustible particulate material added to the fracturing fluid and pumped into the fracture during the stimulation treatment. Ignition of the explosive, implosive, or rapidly combustible particulate material may cause detectable energy events (e.g., micro-seismic events, high energy events, etc.) which generate acoustic waves from within the fracture space. These detectable energy events travel through the formation and may be detected by seismic sensors positioned at the surface, in local observation wells, or in the wellbore from which the particulate material was released. However, these methods may have significant drawbacks, including the transport and handling of explosive particulate material at the surface and while pumping, the exposure of explosive particulate material to very high pressures, difficulty in controlling the timing of the explosions given their lengthy exposure to fracturing fluids, difficulty in igniting the explosive particulate material, etc.

Explosive, implosive, or rapidly combustible particulate material may also be used to enhance a complex fracture network by expanding the fractures within the complex fracture network. Once such example method may involve pumping the explosive particulate material into the complex fracture network whereby the explosive particulate material is then ignited from within the fracture network to enhance the fracture network. However, these methods may have the same significant drawbacks mentioned above, including the danger and difficulty of transport and handling of the explosive particles at the surface and while pumping. Further, the particulate material is only able to be ignited once. Therefore, more of the explosive particulate material is required to be pumped into the primary fracture and portions of the complex fracture network if present for subsequent mapping or fracture enhancement operations to be performed.

### BRIEF DESCRIPTION OF THE DRAWINGS

Illustrative examples of the present disclosure are described in detail below with reference to the attached drawing figures, which are incorporated by reference herein, and wherein:

FIG. 1 illustrates an example fracturing system used to perform a fracturing method in a subterranean formation surrounding a wellbore;

FIG. 2 illustrates a method for propping a primary fracture and fracture network through the introduction of various types of propping fluids into the primary fracture and fracture network;

FIG. 3 illustrates a method for enhancing a primary fracture and a fracture network through the ignition of various types of electrically controlled propellants placed into the primary fracture and fracture network;

FIG. 4 illustrates an example method of using seismic sensors to detect and measure body waves generated by detectable energy events caused during treatment with the methods of enhancing a primary fracture and fracture network described in FIG. 3.

The illustrated figures are only exemplary and are not intended to assert or imply any limitation with regard to the environment, architecture, design, or process in which different examples may be implemented.

### DETAILED DESCRIPTION

The present disclosure relates to the use of electrically controlled propellants for fracturing operations and more particularly to the use of electrically controlled propellants to enhance complex fracture networks and to measure the effective dimensions of propped fractures.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Examples of the methods described herein comprise the use of an electrically controlled propellant (referred to herein as “ECP” or “ECPs”). The ECPs may be either solid propellant grains or liquid monopropellants, both of which may be electrically ignitable and capable of sustained controllable combustion at wellbore pressure. The ECPs are not ignited by flame, spark, or shock. However, the ECPs may be ignited when an electric current of sufficient magnitude is applied to the ECPs. The ECPs may continue to burn until the electric current is removed. The ECPs may be reignited through repeat application of the electric current. As the ECPs are inert unless exposed to a sufficient electric current to initiate ignition, the transport and handling of the ECPs may be less dangerous relative to other types of combustible particulate material that ignite by flame, spark, or shock. Further, since passing electrical current through the ECPs induces ignition/combustion, pyrotechnic ignition may not be required for mapping and/or fracture enhancement. As such, use of the ECPs may remove some of the risks associated with pyrotechnic ignition practices.

Generally, the ECPs comprise a mixture of a binder and an oxidizer. In some specific examples, the binder may be an ionomer oxidizer binder. Examples of the binder may include, but are not limited to, polyvinylamine nitrate, polyvinyl alcohol, polyethylenimine nitrate, copolymers of hexafluoropropylene and vinylidene fluoride; terpolymers of tetrafluoroethylene, vinylidene fluoride, and hexafluoropropylene; copolymers of tetrafluoroethylene and propylene; terpolymers of ethylene, tetrafluoroethylene, perfluoromethylvinylether; and derivatives thereof, and mixtures thereof. Example polymers of the binder may include homopolymers, copolymers, terpolymers, and so on. One specific example of a binder copolymer is a polyvinyl alcohol and polyvinylamine nitrate co-polymer. Examples of the oxidizer may include, but are not limited to, ammonium nitrate, hydroxylamine nitrate, hydroxylammonium nitrate, ethanolamine nitrate, ethylene diamine dinitrate, ethylamine nitrate, methylamine nitrate, methyl ammonium nitrate, hydroxyethylammonium formate, hydrazine nitrate, potassium perchlorate, potassium salts, derivatives thereof, and mixtures thereof. The binder and the oxidizer may be mixed to form the ECP in any combination, concentration, and/or ratio. With the benefit of this disclosure, one of ordinary skill in the art will be able to select an appropriate ECP for a given application. As discussed above, the ECPs may comprise solid propellant grains or liquid monopropellants. With the benefit of this disclosure, one of ordinary skill in the art will be able to prepare the ECPs as solid propellant grains or liquid monopropellants as desired.

The ECPs may further comprise additional additives including, but not limited to, mobile phase liquids, such as, N,n-alkylpyridinium nitrates; epoxy resins, such as glycidylmethacrylate; crosslinking agents, such as boric acid; combustion modifier additives, such as 5-aminotetrazole, 1,2,4-triazole, polyethanolaminobutyne nitrate, 5-aminotetrazole complexes of chromium (III), iron (III) and copper (II) either alone or in combination with each other and/or with an alkali earth chloride such as potassium or sodium chloride; fuel additives, such as α-cyclodextrin, β-cyclodextrin, γ-cyclodextrin, xylose, sorbitol, amylose, amylopectin, hydroxyethyl cellulose, hydroxypropyl cellulose, and methyl hydroxyethyl cellulose; metalized fuels, such as aluminum, boron, tungsten, zirconium or a glass phase metal selected from the group of glassy boron, tungsten, molybdenum and zirconium; mass enhancing non-fuel metals, such as gold, platinum, tungsten or zirconium. The ECP additives may be added to the ECP in any combination, concentration, and/or ratio with any other additive and/or component of the ECP. With the benefit of this disclosure, one of ordinary skill in the art will be able to select an appropriate additive for the ECP to modify the ECP as desired.

The ECPs generally comprise particle sizes ranging from about 0.1 μm to about 3000 μm. In some examples, the ECPs comprise particle sizes ranging from about 5 μm to about 500 μm. The particle size may range from any lower limit to any upper limit and encompass any subset between the upper and lower limits. Some of the lower limits listed above may be greater than some of the listed upper limits. One skilled in the art will recognize that the selected subset will require the selection of an upper limit in excess of the selected lower limit. Therefore, it is to be understood that every range of values is encompassed within the broader range of values. For example, the particle size of the conductive material may be about 0.1 μm, about 1 μm, about 5 μm, about 10 μm, about 100 μm, about 500 μm, about 1000 μm, or about 3000 μm.

Examples of the methods described herein comprise the use of an electroconductive agent (referred to herein as “EXA” or “EXAs”). The EXA may be used to assist in the transmission of electricity into a primary fracture and/or a fracture network to ignite the ECP. The EXA generally comprises conductive materials which may include, but are not limited to, carbon nanotubes, vanadium nanotubes, copper nanotubes, graphene, graphene oxide, graphite powder, copper or silver nanowires, copper powder, iron powder, silver powder, zinc powder, brass powder, tin powder, composite particles such as catalysts decorated with nanowires or nanotubes, or combinations thereof. The conductive materials generally comprise particle sizes ranging from about 1 nm to about 250 nm. In some examples, the conductive materials comprise particle sizes ranging from about 1 nm to about 50 nm. The particle size may range from any lower limit to any upper limit and encompass any subset between the upper and lower limits. Some of the lower limits listed above may be greater than some of the listed upper limits. One skilled in the art will recognize that the selected subset will require the selection of an upper limit in excess of the selected lower limit. Therefore, it is to be understood that every range of values is encompassed within the broader range of values. For example, the particle size of the conductive material may be about 1 nm, about 25 nm, about 50 nm, about 100 nm, about 150 nm, about 200 nm, or about 250 nm. With the benefit of this disclosure, one of ordinary skill in the art will be able to select an EXA for a given application and will be able to determine the appropriate particle size of the EXA for the given application.

In some examples the EXAs may be added to a treatment fluid, such as a proppant-free fluid, to fracture a subterranean formation. The EXAs may then enter the primary fracture and any fractures within a fracture network, if present, to form a conductive network therein.

In some examples one or more of the EXAs may be added to a resin to form an electroconductive resin (referred to herein as “EXR” or “EXRs”). The chosen resin may also possess a degree of conductivity. Curable resins that are suitable for use in the present invention include, but are not limited to, two component epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, or mixtures thereof. Some suitable resins, such as epoxy resins, may be cured with an internal catalyst or activator so that when pumped down hole, they may be cured using only time and temperature. Other suitable resins, such as furan resins, generally require a time-delayed catalyst or an external catalyst to help activate the polymerization of the resins if the cure temperature is low (i.e., less than 250° F.), but will cure under the effect of time and temperature if the formation temperature is above about 250° F., preferably above about 300° F. With the benefit of this disclosure one of ordinary skill in the art will be able to select a suitable resin for a given application and will be able to determine whether a catalyst is required for the desired curing characteristics.

In some examples the EXR may be incorporated into an aqueous base fluid to produce an aqueous-based emulsion. This aqueous-based emulsion may then be introduced into a proppant-free fluid. When the proppant-free fluid is used to fracture a subterranean formation, the EXR may adhere to and form a conductive membrane on the fracture faces. For example, the EXR may be used to coat the faces of the primary fracture and any fractures within a fracture network, if present, to form a conductive network therein.

In some examples the EXR may be added to various sized proppant particulates used to prop open fractures and form proppant packs within fractures. The EXR may be added to the proppant particulates to coat the proppant particulates and to form electroconductive proppant particulates (referred to herein as “EXPP” or “EXPPs”). Suitable proppant particulates include, but are not limited to, sand, natural sand, quartz sand, bauxite and other ore, ceramic materials, glass materials, particulate garnet, metal particulates, nylon pellets, polymer materials, polytetrafluoroethylene materials, nut shell pieces, seed shell pieces, fruit pit pieces, wood, or combinations thereof. Suitable proppant particulates may also include composite particulates comprising a binder and a filler material wherein suitable filler materials include silica, alumina, fumed carbon, carbon black, graphite, mica, titanium dioxide, meta-silicate, calcium silicate, various clays and clay families (e.g., kaolin, halloysite, nacrite, smectite, saponite, sepiolite montmorillonite, etc.), talc, zirconia, boron, slag, fly ash, hollow glass microspheres, solid glass, or combinations thereof.

As discussed, the proppant particulates may be variously sized. As used herein, the term “fine,” when used to describe proppant particulates, for example, fine proppant particulates of fine EXPPs, refers to proppant particulates having an average particle size distribution in the range of from about 0.1 micrometers (μm) to about 100 μm, encompassing any value and subset therebetween, such as about 1 μm to about 20 μm, or about 20 μm to about 40 μm, or about 40 μm to about 60 μm, or about 60 μm to about 80 μm, or about 80 μm to about 100 μm, encompassing any value and subset therebetween. In some embodiments, the fine proppant particulates or fine EXPPs have an average particle size distribution in the range of from a lower limit of about 0.1 μm, 1 μm, 5 μm, 10 μm, 15 μm, 20 μm, 25 μm, 30 μm, 35 μm, 40 μm, 45 μm, and 50 μm to a higher limit of about 100 μm, 95 μm, 90 μm, 85 μm, 80 μm, 75 μm, 70 μm, 65 μm, 60 μm, 55 μm, and 50 μm, encompassing any value and subset therebetween. As used herein, the term “medium,” when used to describe proppant particulates, for example, medium proppant particulates or medium EXPPs, refers to proppant particulates having an average particle size distribution in the range of from about 100 μm to about 200 μm, encompassing any value and subset therebetween, such as about 100 μm to about 120 μm, or about 120 μm to about 140 μm, or about 140 μm to about 160 μm, or about 160 μm to about 180 μm, or about 180 μm to about 200 μm, encompassing any value and subset therebetween. In some examples, the medium proppant particulates or medium EXPPs have an average particle size distribution in the range of from a lower limit of about 100 μm, 105 μm, 110 μm, 115 μm, 120 μm, 125 μm, 130 μm, 135 μm, 140 μm, 145 μm, and 150 μm to an upper limit of about 200 μm, 195 μm, 190 μm, 185 μm, 180 μm, 175 μm, 170 μm, 165 μm, 160 μm, 155 μm, and 150 μm, encompassing any value and subset therebetween. As used herein, the term “coarse,” when used to describe proppant particulates, for example, coarse proppant particulates of coarse EXPPs, refers to proppant particulates having an average particle size distribution in the range of from about 200 μm to about 900 μm, encompassing any value and subset therebetween, such as about 200 μm to about 340 μm, or about 340 μm to about 480 μm, or about 480 μm to about 620 μm, or about 620 μm to about 760 μm, or about 760 μm to about 900 μm, encompassing any value and subset therebetween. In some embodiments, the coarse proppant particulates or coarse EXPPs have an average particle size distribution in the range of from a lower limit of about 200 μm, 250 μm, 300 μm, 350 μm, 400 μm, 450 μm, 500 μm, and 550 μm to an upper limit of about 900 μm, 850 μm, 800 μm, 750 μm, 700 μm, 650 μm, 600 μm, and 550 μm, encompassing any value and subset therebetween. Each of these values is critical to the examples of the present disclosure and may depend on a number of factors including, but not limited to, the type of proppant particulate selected, the type of subterranean formation being treated, the desired complex fracture geometry, and the like. While overlap in these size ranges may be possible, the selection of the sized proppant particulates may be dependent on a number of factors including, but not limited to, the material of the particulates, the shape of the particulates, the type of subterranean formation, the size of the dominate fracture and the presence of or desire to create a fracture network, and the like.

Generally, the disclosed methods may use an electric power generation device to transmit an electric current into the primary fracture and fracture network, if present, to ignite any ECPs positioned within the primary fracture and fracture network. The electric power generation device may be on the surface or within the wellbore. Any of the electroconductive materials disclosed herein, for example, the EXAs, the EXRs, and/or the EXPPs, may be used to conduct the electric current allowing it to flow into the primary fracture and fracture network, if present, where the electric current may contact and ignite ECPs. There are many methods for providing the electric current downhole, for example, an electric power generation device coupled to a conductor cable which has been run into the wellbore. The conductor cable may comprise diodes to regulate the electric current as desired. The conductor cable may be run to the point in which the electric current is desired and may then be used to transmit the electric current. As another example, a plurality of electrodes may be placed in the wellbore at a distance apart from each other, and the electric power generation device may be coupled to one or more of the electrodes in the plurality. A voltage difference may be established between the individual electrodes within the plurality to create an electric current which flows between the electrodes if a sufficient conducting path resides between the electrodes. If the electrodes are placed such that any of the electroconductive materials disclosed herein, for example, the EXAs, the EXRs, and/or the EXPPs, reside between the electrodes, a sufficient conducting path may be created. The electric current may then flow between the electrodes and also into the primary fracture and the fracture network via the electroconductive materials to ignite the ECPs present therein. As the ECPs only require an electric current exceeding their ignition threshold to ignite, the method of transmitting the electric current need only be capable of transmitting an electric current exceeding the ignition threshold of the ECPs present within the primary fracture and fracture network.

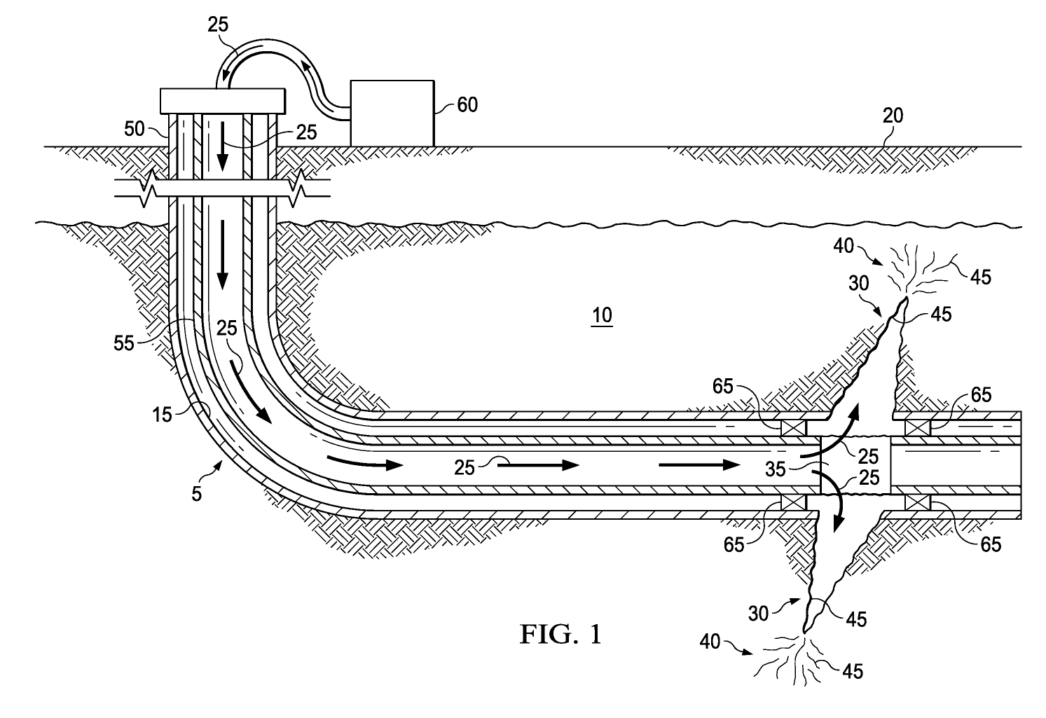

FIG. 1 shows an example fracturing system 5 used to perform a fracturing method in subterranean formation 10 surrounding a wellbore 15. The subterranean formation 10 may include one or more subterranean formations or a portion of a subterranean formation. The wellbore 15 extends from the surface 20. In the example illustrated by FIG. 1, a proppant-free fluid 25 is injected at an injection rate greater than the fracture gradient of subterranean formation 10 in order to produce primary fracture 30 in the area of subterranean formation 10 surrounding the horizontal portion of wellbore 15. The proppant-free fluid 25 may be of any desired viscosity. Fracturing tool 35 may be used to inject proppant-free fluid 25 at the desired injection rate and/or to target proppant-free fluid 25 at the area of subterranean formation 10 in which fracturing is desired. Although shown as vertical deviating to horizontal, wellbore 15 may include horizontal, vertical, slant, curved, and other types of wellbore geometries and orientations, and the example fracturing methods described herein may be applied to any area of subterranean formation or formations surrounding any portion or portions of a wellbore. In the illustrated example, proppant-free fluid 25 has been used to produce primary fracture 30 and fracture network 40. The fracture network 40 may generally comprise secondary fractures, tertiary fractures, etc. of various sizes and is typically branched off of the primary fracture 30 and may comprise additional branching off of any of the fractures disposed within the fracture network 40. In some alternative examples, proppant-free fluid 25 may only be used to form primary facture 30. The proppant-free fluid 25 used to form primary fracture 30 may optionally include any of the ECPs, EXAs, or EXRs disclosed and described herein. For example, the proppant-free fluid used to form primary fracture 30 may include electroconductive particles with a particle size ranging between 1 nm and 250 nm and comprising electroconductive materials including, but not limited to, carbon nanotubes, vanadium nanotubes, graphene, graphite powder, copper or silver nanowires, copper powder, iron powder, silver powder, zinc powder, brass powder, tin powder, composite particles such as catalysts decorated with nanowires or nanotubes, or combinations thereof. These EXAs may be deposited into the primary fracture 30, as well any fractures within the fracture network 40, if such a fracture network 40 was formed. Alternatively, or in addition to, the proppant-free fluid 25 may comprise an EXR comprising one or more of any of the EXAs described herein and further including two component epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, or mixtures thereof. The ECAs within the EXR may be adhered to the fracture faces 45 of the primary fracture 30, as well as any fracture faces 45 of any fractures within a fracture network 40, if such a fracture network 40 was formed, to form an electroconductive membrane along the fracture faces 45. Further alternatively, or in addition to, the proppant-free fluid 25 may include any of the ECPs described herein. For example, the proppant-free fluid may comprise one or more ECPs comprising solid propellant grains, liquid monopropellants, or combinations thereof. The wellbore 15 may include a casing 50 that is cemented or otherwise secured to the wall of the wellbore 15. The wellbore 15 may be uncased or include uncased sections. Perforations may be formed in the casing 50 to allow fracturing fluids, for example, proppant-free fluid 25 and/or other materials, to flow into the subterranean formation 10. In cased wells perforations can be formed using shape charges, a perforating gun, hydrojetting and/or other tools.

The wellbore 15 is illustrated as comprising a work string 55 disposed within and descending from the surface 20 into the wellbore 15. A pump and mixer system 60 is coupled to work string 55 to convey the proppant-free fluid 25 into the wellbore 15. The work string 55 may include coiled tubing, jointed pipe, and/or other structures configured to convey a treatment fluid into wellbore 15. The work string 55 may include flow control devices, bypass valves, ports, and/or other tools or well devices that are capable of controlling the flow of a treatment fluid from the interior of the work string 55 into the subterranean formation 10. For example, the work string 55 may include fracturing tool 35 which comprises ports adjacent to a wall of the wellbore 15 to apply the proppant-free fluid 25 directly onto the desired area of subterranean formation 10, and/or the work string 55 may include ports that are spaced apart from the wall of the wellbore 15 to convey the proppant-free fluid 25 into an annulus in the wellbore 15 between the work string 55 and the wall of the wellbore 15.

In the illustrated example, the work string 55 and/or the wellbore 15 includes one or more sets of packers 65 that may seal the annulus between the work string 55 and wellbore 15 to define an interval of the wellbore 15 into which a treatment fluid, for example, a proppant-free fluid 25, may be pumped. FIG. 1 illustrates two packers 65, defining an uphole boundary of the interval and a downhole boundary of the interval.

As discussed above, the example method illustrated by FIG. 1 comprises a fracture network 40 branching off from a primary fracture 30. As illustrated, the rock matrix of the subterranean formation 10 is of a type that when fractured produces both a primary fracture 30 in the near field and a secondary, induced, fracture network 40 in the far field. In some examples, the fracture network 40 may propagate from or near the ends and edges of the primary fracture 30. In some examples, the subterranean formation 10 may be a low permeability zone having a permeability of 1 mD or less. For example, the subterranean formation 10 may be a shale formation. In some examples, the rock matrix of the subterranean formation 10 may include cleating or natural fractures (i.e., those that existed prior to, and were not caused by, a fracturing method). The natural fractures may run generally in a direction that is parallel to the primary fracture 30. The fractures of the fracture network 40 may run in many directions, including directions non-parallel, and in certain examples, perpendicular to the direction of the primary fracture 30. As a result, the fractures of the fracture network 40 may link some of the natural fractures to the primary fracture 30.

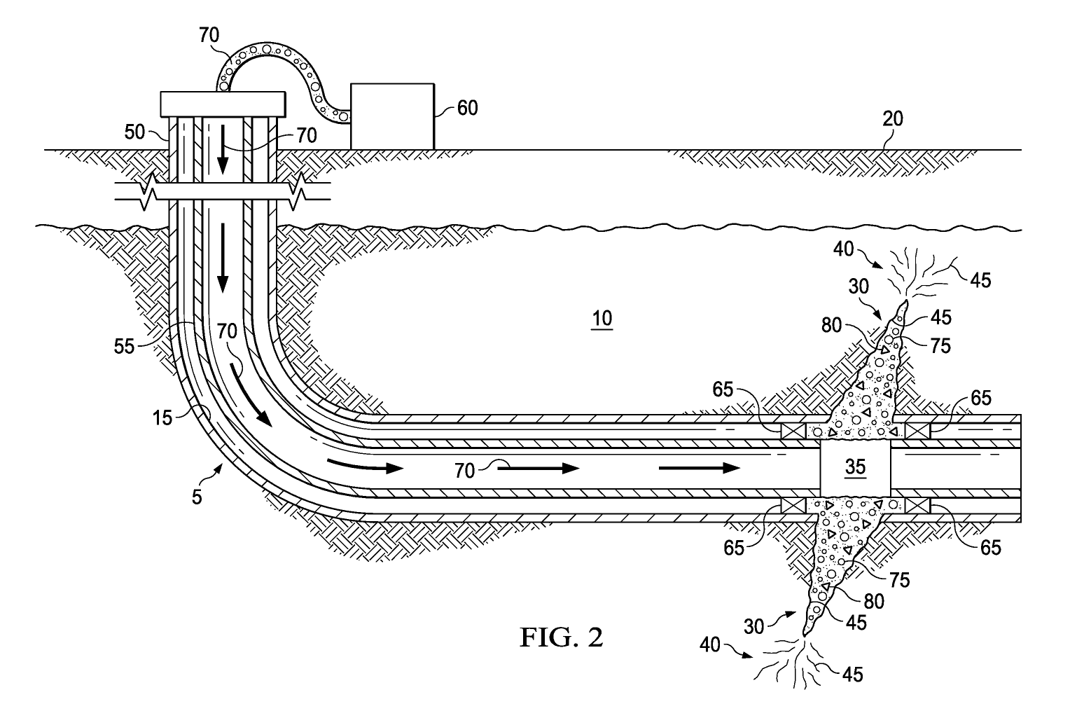

As illustrated in FIG. 2, the example fracturing method is then continued with one or more treatment stages directed to introducing ECPs into primary fracture 30 and the fracture network 40, if present, and to propping the primary fracture 30 and the fracture network 40, if present, via one or more types of propping fluid 70. Several different propping fluids 70 may be used. The propping fluids 70 may be of any desired viscosity. In some examples, the propping fluids 70 may be used to form the fracture network 40 and to access/connect natural fractures to the primary fracture 30. If multiple propping fluids 70 are used, the propping fluids 70 may be of different viscosities. Generally, each type of propping fluid 70 comprises at least one species of proppant particulate 75. The at least one species of proppant particulate 75 has particle size within the size ranges described above (e.g., fine, medium, and/or coarse sized proppant particulates). Some examples of the propping fluid 70 may comprise multiple species of proppant particulates 75 having different amounts, sizes, and/or concentrations of proppant particulates 75. Additionally, the proppant particulates 75 may be coated with the EXRs described above to form EXPPs which may be used to prop the primary fracture 30 and the fracture network 40, if present, and to also conduct an electric current into the primary fracture 30 and the fracture network 40, if present. Additionally, the propping fluid 70 may comprise any of the ECPs 80 described herein. For example, the propping fluids may comprise one or more ECPs 80 comprising solid propellant grains, liquid monopropellants, or combinations thereof. In the illustrated embodiment, the propping fluid 70 comprises ECPs 80 and proppant particulates 75 and has been used to introduce both ECPs 80 and proppant particulates 75 into the primary fracture 30 and the fracture network 40. The propping fluids 70 may also comprise any of the EXAs and/or EXRs described herein. More than one propping fluid 70 may be used in the example methods, and different types of propping fluids 70 comprising different components may be used in series in a specific desired sequence. For example, the treatment stages introduce proppant particulates 75 such that the smaller fractures within the fracture network 40 are capable of being propped by fine and medium proppant particulate 75. In other treatment stages, the propping fluids 70 can provide coarse proppant particulates to prop the primary fracture 30. The treatment stages can be arranged to provide the various sizes of proppant particulates 75 intermixed and/or some stages can provide substantially just one size range of proppant particulate 75. As discussed above, any of the proppant particulates 75 used in any of the propping fluids 70 of any of the treatment stages may be EXPPs as desired.

With continued reference to FIG. 2, the pump and mixer system 60 is used to convey the propping fluids 70 into the wellbore 15. Fracturing tool 35, which comprises ports adjacent to a wall of the wellbore 15, may be used to apply the propping fluid 70 directly into the primary fracture 30 and the fracture network 40, and/or the work string 55 may include ports that are spaced apart from the wall of the wellbore 15 to convey the propping fluid 70 into an annulus in the wellbore 15 between the work string 55 and the wall of the wellbore 15. As discussed above and as illustrated in FIG. 2, the propping fluid 70 may be used to introduce both the ECPs 80 and proppant particulates 75 into the primary fracture 30 and the fracture network 40.

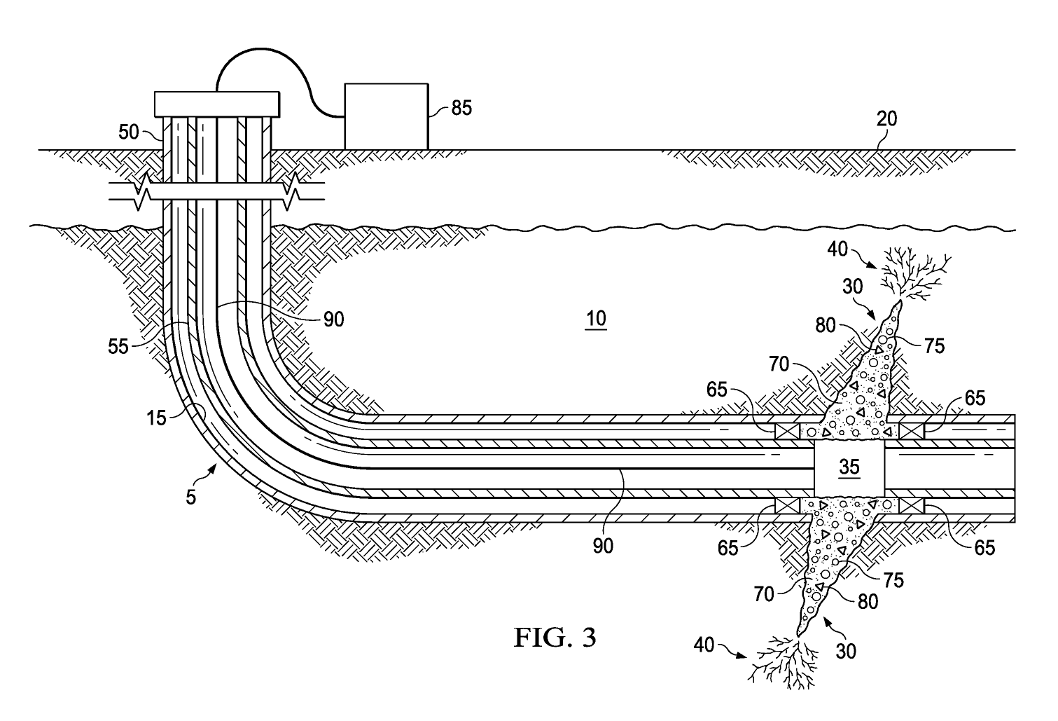

FIG. 3 illustrates a method of enhancing the fracture network 40 while maintaining pressure within the primary fracture 30 and the fracture network 40. Pressure within the primary fracture 30 and the fracture network 40 is maintained via the methods discussed above regarding FIG. 2. When the treatment stages discussed in FIG. 2 have been successfully performed, an electric power generation device 85 may be used to conduct electric current via a conductor cable 90 into primary fracture 30 and fracture network 40. Although FIG. 3 depicts the use of an electric power generation device 85 and conductor cable 90, it is to be understood that the manner of providing electric current to the electroconductive materials in the primary fracture 30 and fracture network 40 is irrelevant so long as the manner is capable of providing an electric current of sufficient voltage and magnitude to ignite the ECPs 80 previously introduced to the primary fracture 30 and fracture network 40 via the proppant-free fluid 25 and/or the propping fluid 70. As described, the electric current is transmitted to the primary fracture 30 and fracture network 40 and conducted in the primary fracture 30 and fracture network 40 via any of the electroconductive materials (e.g., the EXAs, EXRs, EXPPs) introduced via the proppant-free fluid 25 and/or the propping fluid 70. The electric current is used to ignite the ECPs 80 previously introduced to the primary fracture 30 and fracture network 40 via the proppant-free fluid 25 and/or the propping fluids 70. The ignited ECPs 80 may deflagrate or explode and release gas and increase the pressure within any of the fractures in which they may be disposed. The ignition of the ECPs 80 may be used to generate additional fractures and to enhance already formed fractures within the primary fracture 30 and fracture network 40, as illustrated in FIG. 3. The proppant particulates 75 within the propping fluid 70 used to maintain pressure within the primary fracture 30 and fracture network 40 may then be allowed to prop the new and/or enhanced fractures within the primary fracture 30 and fracture network 40. When desired, the electric current may be withdrawn, and the ignition of the ECPs 80 may cease. If desired, the electric current may be reapplied to reignite the ECPs 80. This process may be repeated as desired.

In some applications, no proppant may be used. For these completely proppant-free fracturing applications, if desired, the localized forces created by the combustion or deflagration of the ECPs may cause local yielding of the rock along the fracture face creating a rough surface that may retain flow channels after the fracture has closed to enable enhanced productivity.

An example fracturing method comprises injecting a high-viscosity, proppant-free fluid 25 containing at least one species of EXR at an injection rate above the fracture gradient of a subterranean formation 10 to create a primary fracture 30 in the subterranean formation 10 and allowing the EXR to adhere the EXAs within the EXR to the fracture faces 45 of the primary fracture 30 such that a conductive membrane may be formed on said fracture faces 45. A first low-viscosity propping fluid 70 comprising at least one species of liquid monopropellant ECP 80, at least one species of EXA, and at least one species of fine proppant particulate 75, may then be introduced into the primary fracture 30 to induce generation of a fracture network 40 and/or access/connect natural fractures while also allowing the at least one species of liquid monopropellant ECP 80 to penetrate deep into the primary fracture 30 and the fracture network 40. A second low-viscosity propping fluid 70 comprising at least one species of medium or coarse EXPP 75 and at least one species of solid propellant grain ECP 80 may be introduced into the primary fracture 30 and the fracture network 40. An electric current may then be introduced into the primary fracture 30 and the fracture network 40 and conducted via the electroconductive materials placed within the primary fracture 30 and the fracture network 40. The electric current may ignite the at least one species of liquid monopropellant ECP 80 and the at least one species of solid propellant grain ECP 80 to enhance the primary fracture 30 and the fracture network 40. The proppant particulates 75 are allowed to prop the enhanced primary fracture 30 and the fracture network 40. The electric current may be withdrawn and reapplied as desired.

Another example fracturing method comprises injecting a high-viscosity, proppant-free fluid 25 containing at least one species of EXR at an injection rate above the fracture gradient of a subterranean formation 10 to create a primary fracture 30 in the subterranean formation 10 and allowing the EXR to adhere the EXAs within the EXR to the fracture faces 45 of the primary fracture 30 such that a conductive membrane may be formed on said fracture faces 45. A first low-viscosity propping fluid 70 comprising at least one species of solid propellant grain ECP 80, at least one species of EXA, and at least one species of fine proppant particulate 75, may then be introduced into the primary fracture 30 to induce generation of a fracture network 40 and/or access/connect natural fractures while also allowing the at least one species of solid propellant grain ECP 80 to penetrate deep into the primary fracture 30 and the fracture network 40. A second low-viscosity propping fluid 70 comprising at least one species of medium or coarse EXPP 75 and at least one species of solid propellant grain ECP 80 may be introduced into the primary fracture 30 and the fracture network 40. An electric current may then be introduced into the primary fracture 30 and the fracture network 40 and conducted via the electroconductive materials placed within the primary fracture 30 and the fracture network 40. The electric current may ignite the at least one species of solid propellant grain ECP 80 to enhance the primary fracture 30 and the fracture network 40. The proppant particulates 75 are allowed to prop the enhanced primary fracture 30 and the fracture network 40. The electric current may be withdrawn and reapplied as desired.

Another example fracturing method comprises injecting a high-viscosity, proppant-free fluid 25 containing at least one species of liquid monopropellant ECP 80 and at least one species of EXR at an injection rate above the fracture gradient of a subterranean formation 10 to create a primary fracture 30 in the subterranean formation 10 and allowing the EXR to adhere the EXAs within the EXR to the fracture faces 45 of the primary fracture 30 such that a conductive membrane may be formed on said fracture faces 45. A first low-viscosity propping fluid 70 comprising at least one species of liquid monopropellant ECP 80, at least one species of EXA, and at least one species of fine proppant particulate 75, may then be introduced into the primary fracture 30 to induce generation of a fracture network 40 and/or access/connect natural fractures while also allowing the at least one species of liquid monopropellant ECP 80 to penetrate deep into the primary fracture 30 and the fracture network 40. A second low-viscosity propping fluid 70 comprising at least one species of medium or coarse EXPP 75 and at least one species of solid propellant grain ECP 80 may be introduced into the primary fracture 30 and the fracture network 40. An electric current may then be introduced into the primary fracture 30 and the fracture network 40 and conducted via the electroconductive materials placed within the primary fracture 30 and the fracture network 40. The electric current may ignite the at least one species of liquid monopropellant ECP 80 and the at least one species of solid propellant grain ECP 80 to enhance the primary fracture 30 and the fracture network 40. The proppant particulates 75 are allowed to prop the enhanced primary fracture 30 and the fracture network 40. The electric current may be withdrawn and reapplied as desired.

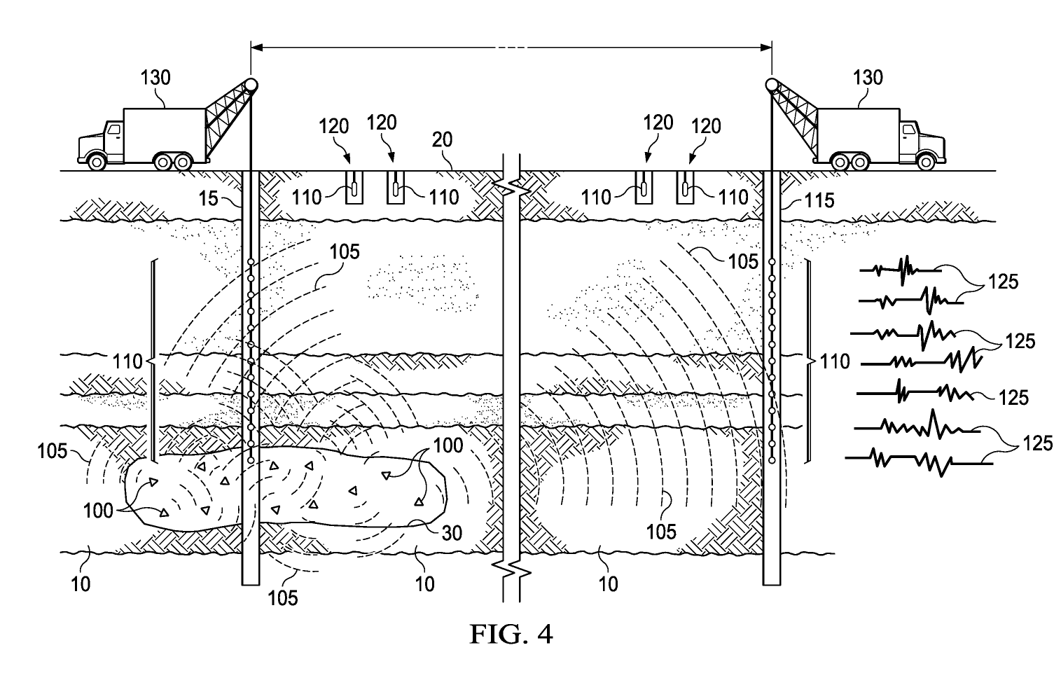

FIG. 4 illustrates an example method of monitoring a treated well with arrayed sensors for the detection of and recording of detectable energy events 100 caused during treatment with the methods of enhancing a fracture network 40 described above. Without limitation by theory, the ignition of the ECPs described above may cause detectable energy events which may generate measurable body waves 105 from within the primary fracture 30 and/or the fracture network 40. These detectable energy events 100 may travel through the subterranean formation 10 and be detected by seismic sensors positioned at the surface 20, in local observation wells, or in the wellbore 15 from which the particles are released. As used herein, the term “detectable energy event” (and similar) refers to any event that causes a small but detectable change in stress and pressure distributions in a subterranean formation 10, including those caused by slippages, deformation, and breaking of rock along natural fractures, bedding or faults, creation of fractures or re-opening of fractures, and events artificially created by fracturing operations or caused by an explosion, implosion, exothermic reaction, etc. Examples of such detectable energy events may include, but are not limited to, micro-seismic events, high energy events, and the like.

As illustrated in FIG. 4, a detectable energy event 100 generates body waves 105. There are two types of body waves 105: compression, pressure, or primary waves (called P-waves), and shear or secondary waves (called S-waves). The P-waves and S-waves travel through the earth formations at speeds governed by the bulk density and bulk modulus (rock mechanical properties) of the subterranean formation 10. The rock mechanical properties of the subterranean formation 10 vary according to mineralogy, porosity, fluid content, elastic constants, in situ stress profile, and temperature. Each type of body waves 105 may be detected and measured by corresponding sensor equipment, generally referred to herein as “seismic sensors” or “acoustic sensors” or similar. The body waves 105 may propagate away from each detectable energy event 100 in all directions and travel through the subterranean formation 10.

The body waves 105 may be detected by a plurality of seismic sensors 110. These seismic sensors 110 are capable and configured to detect and measure detectable energy events 100. Examples of seismic sensors may include, but are not limited to, seismographs, tilt meters, piezoelectric sensors, accelerometers, transducers, ground motion sensors, multi-axis sensors, geophones, hydrophones, fiber distributed antenna systems, or combinations thereof. As illustrated in FIG. 2, the seismic sensors 110 may be placed in a wellbore of one or more monitoring wells 115. Sensors can also be placed at or near the surface 20, preferably in shallow boreholes 120 drilled for that purpose. A typical shallow borehole 120 may be ten to forty feet deep.

The recorded body waves 105 data may be analyzed, in a process referred to as “mapping” “imaging,” which calculates locations of the events in 3-dimensional reservoir space. Typically, a location information solution based on a statistical best-fit method is used to map an event in terms of distance, elevation and azimuth. Analysis software for analyzing and displaying the measurements and results is available from Halliburton Energy Services, Inc., under the brand names such as FRACTRAC® and TERRAVISTA®.

As illustrated in the FIG. 4, once primary fracture 30 has been formed adjacent to wellbore 15 in subterranean formation 10, detectable energy events are caused according to the methods described above which generally comprise the ignition of an ECP 80 through contact with an electric current propagated into primary fracture 30. The ignition of the ECP 80 may generate detectable energy events so long as the ECP 80 continues to burn. The produced detectable energy events may generate body waves 105. The body waves 105 may propagate away from each detectable energy events in all directions and travel through the subterranean formation 10. The body waves 105 may be detected by a plurality of seismic sensors 110, which may be located in wellbore 15 as illustrated in FIG. 4, at or near the surface in shallow boreholes 120 as illustrated in FIG. 4, or in one or more observation or monitoring wells 115 drilled near wellbore 15 as illustrated in FIG. 4. Seismic sensors 110 may detect and measure the body waves 105, and provide data 125. The data 125 may be transferred to data processing systems 130 for preliminary well site analysis. In-depth analysis is typically performed after the raw data is collected and quality-checked. After final analysis, the results (maps of the fracture networks) are invaluable in development planning for the reservoir and field, and in designing future hydraulic fracturing jobs.

Methods of enhancing a fracture in a subterranean formation are provided. An example method comprises introducing a proppant-free fluid into the fracture; introducing a propping fluid into the fracture, wherein the propping fluid comprises a proppant particulate and an electrically controllable propellant; transmitting an electric current into the fracture; allowing the electrically controllable propellant to ignite within the fracture; and withdrawing the electric current. The proppant-free fluid may further comprise a liquid monopropellant electrically controllable propellant. The electrically controllable propellant may be a solid propellant grain. The electrically controllable propellant may be a liquid monopropellant electrically controllable propellant. The proppant may be a fine proppant particulate. The method may further comprise introducing a second propping fluid into the fracture after the introduction of the first propping fluid, wherein the second propping fluid comprises a second proppant particulate and a second electrically controllable proppant, wherein the second proppant particulate is a medium or coarse proppant particulate. The proppant-free fluid may further comprise an electroconductive agent. The proppant-free fluid may further comprise an electroconductive resin. The proppant particulate may be an electroconductive proppant particulate.

Methods of obtaining data from a portion of a subterranean formation are provided. An example method comprises placing an electrically controllable propellant into a fracture in the subterranean formation; transmitting an electric current into the fracture; allowing the electrically controllable propellant to ignite within the fracture to create a detectable energy event, wherein the detectable energy event generates a body wave; detecting the body wave with a seismic sensor; and analyzing the detected body wave to produce body wave data. The seismic sensors may comprise a seismic sensor selected from the group consisting of seismographs, tilt meters, piezoelectric sensors, accelerometers, transducers, ground motion sensors, multi-axis sensors, geophones, hydrophones, fiber distributed antenna systems, and combinations thereof. The seismic sensors may be disposed in a wellbore adjacent to the fracture, at or near the surface in a shallow borehole, in a monitoring well, or a combination thereof. The method may further comprise placing an electroconductive agent in the fracture. The method may further comprise placing an electroconductive resin in the fracture. The method may further comprise placing an electroconductive proppant in the fracture. The electrically controllable propellant may be a solid propellant grain. The electrically controllable propellant may be a liquid monopropellant electrically controllable propellant.

Systems for enhancing a fracture in a subterranean formation are provided. An example system comprises a proppant-free fluid comprising an electroconductive resin; a propping fluid comprising a proppant particulate and an electrically controllable propellant; a fracturing tool configured to inject at least one of the proppant-free fluid or the propping fluid; and an electric power generation device capable of generating an electric current. The proppant-free fluid may further comprise a liquid monopropellant electrically controllable propellant. The electrically controllable propellant may be a solid propellant grain. The electrically controllable propellant may be a liquid monopropellant electrically controllable propellant. The proppant may be a fine proppant particulate. The method may further comprise introducing a second propping fluid into the fracture after the introduction of the first propping fluid, wherein the second propping fluid comprises a second proppant particulate and a second electrically controllable proppant, wherein the second proppant particulate is a medium or coarse proppant particulate. The proppant-free fluid may further comprise an electroconductive agent. The proppant-free fluid may further comprise an electroconductive resin. The proppant particulate may be an electroconductive proppant particulate.

One or more illustrative examples incorporating the examples disclosed herein are presented herein. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A method of enhancing a fracture in a subterranean formation comprising:
introducing a proppant-free fluid into the fracture;
introducing a propping fluid into the fracture, wherein the propping fluid comprises a proppant particulate and an electrically controllable propellant;
transmitting an electric current into the fracture;
allowing the electrically controllable propellant to ignite within the fracture; and
withdrawing the electric current.

2. The method of claim 1, wherein the proppant-free fluid comprises a liquid monopropellant electrically controllable propellant.

3. The method of claim 1, wherein the electrically controllable propellant is a solid propellant grain.

4. The method of claim 1, wherein the electrically controllable propellant is a liquid monopropellant electrically controllable propellant.

5. The method of claim 1, wherein the proppant particulate is a fine proppant particulate.

6. The method of claim 1, further comprising introducing a second propping fluid into the fracture after the introduction of the first propping fluid, wherein the second propping fluid comprises a second proppant particulate and a second electrically controllable proppant, wherein the second proppant particulate is a medium or coarse proppant particulate.

7. The method of claim 1, wherein the proppant-free fluid further comprises an electroconductive agent.

8. The method of claim 1, wherein the proppant-free fluid further comprises an electroconductive resin.

9. The method of claim 1, wherein the proppant particulate is an electroconductive proppant particulate.

10. A method of obtaining data from a portion of a subterranean formation comprising:
placing an electrically controllable propellant into a fracture in the subterranean formation;
transmitting an electric current into the fracture;
allowing the electrically controllable propellant to ignite within the fracture to create a detectable energy event, wherein the detectable energy event generates a body wave;
detecting the body wave with a seismic sensor; and
analyzing the detected body wave to produce body wave data.

11. The method of claim 10, wherein the seismic sensors comprise a seismic sensor selected from the group consisting of seismographs, tilt meters, piezoelectric sensors, accelerometers, transducers, ground motion sensors, multi-axis sensors, geophones, hydrophones, fiber distributed antenna systems, and combinations thereof.

12. The method of claim 10, wherein the seismic sensors are disposed in a wellbore adjacent to the fracture, at or near the surface in a shallow borehole, in a monitoring well, or a combination thereof.

13. The method of claim 10, further comprising placing an electroconductive agent in the fracture.

14. The method of claim 10, further comprising placing an electroconductive resin in the fracture.

15. The method of claim 10, further comprising placing an electroconductive proppant in the fracture.

16. A system for enhancing a fracture in a subterranean formation comprising:
a proppant-free fluid comprising an electroconductive resin;
a propping fluid comprising a proppant particulate and an electrically controllable propellant;
a fracturing tool configured to inject at least one of the proppant-free fluid or the propping fluid; and
an electric power generation device capable of generating an electric current.

17. The system of claim 16, wherein the proppant-free fluid comprises a liquid monopropellant electrically controllable propellant.

18. The system of claim 16, wherein the electrically controllable propellant is a solid propellant grain.

19. The system of claim 16, wherein the electrically controllable propellant is a liquid monopropellant electrically controllable propellant.

20. The system of claim 16, further comprising a pump and a mixer system coupled to a work string and configured to pump the propping fluid into the work string.
